(19) United States
(12) Patent Application Publication
(10) Pub. No.: US 2017/0326746 A1
(43) Pub. Date: Nov. 16, 2017

(54) MULTI PURPOSE CUTTING AND MARKING TOOL

(71) Applicants: Thomas SLOAN, Prattville, AL (US); Joseph POWELL, JR., Prattville, AL (US)

(72) Inventors: Thomas SLOAN, Prattville, AL (US); Joseph POWELL, JR., Prattville, AL (US)

(21) Appl. No.: 15/151,183

(22) Filed: May 10, 2016

(51) Int. Cl. B26B 29/06; B43L 7/10

(52) U.S. Cl. CPC B26B 29/06; B43L 7/10

(57) ABSTRACT

A drywall cutting device provides cutting and marking in drywall material either parallel or perpendicular to a reference edges. The device comprises a T-shaped with the head and arm portions immovably affixed to one another. The arm of the device carries a slidably adjustable cutting body thereon, with the cutting body being secured through an elongate slot formed in the center of the arm portion of the device.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The instant invention relates generally to cutting devices and more specifically it relates to a drywall cutting tool.

### 2. Description of Related Art Including Information Disclosed Under 37 CFR 1.97 and 37 CFR 1.98

Drywall board is used extensively in the construction of interior regions of all types of public and private structures. Drywall board is generally manufactured in large sheets of 4 feet by 8 feet or larger, and is comprised of a compressed chalk-like substance laminated on each side by a thin cardboard or paper material. These drywall sheets are used as an inexpensive wall or surface cover for interior construction support structures such as wood or concrete and are generally painted or covered with wallpaper trim to fit the cosmetic needs of the particular construction. The construction industry uses drywall board extensively in the construction of interior regions of all types of public and private structures.

Prior art devices in this area include the device shown and described in U.S. Pat. No. 3,107,426, which discloses a utility knife device with a retractable razor blade.

The patent to Hines, U.S. Pat. No. 4,976,037, shows another marking and cutting device. It also shows a means for holding either a pencil or knife blade at the end of the tape, in order to provide the alternative of either scribing or cutting of a surface. But, the pencil or knife held within the container, is offset from end of the tape, and therefore requires some additional calculation for determining the exact dimension being scribed, upon the surface in the first instance.

U.S. Pat. No. 5,083,375 issued to Larry Helm, Sr., titled “Drywall Cutting Device,” describes a T-square like device in which the lower portion of the stem of the device may telescope for extension as required. Two separate tracks are provided, with the cutting head being slidably affixed to the two tracks of the extension and extending thereacross. The device uses a single conventional knife blade, rather than the spaced apart dual roller blades of the present drywall cutting tool. The Helm, Sr. tool is relatively flexible in comparison to the present tool, due to the relatively narrow telescoping arms of the Helm, Sr. tool and their spacing. The positioning of the cutting elements of the present tool outside the channel of the stem portion of the T, results in greater rigidity and more accuracy in forming a cut.

These limitations, and the improvement overcoming these limitations, will be further described hereinafter. None of the above inventions and patents, taken either singly or in combination, is seen to describe the instant invention as claimed.

### BRIEF SUMMARY OF THE INVENTION

In the view of the foregoing disadvantages inherent in the known types of cutting devices now present in the prior art, the present invention provides an improved device for cutting predetermined shapes in dry wall panels. As such, the general purpose of the present invention, which will be described subsequently in greater detail, is to provide a new and improved drywall cutting device, which has all the advantages of the prior art and none of the disadvantages.

Accordingly, the main object of the present invention is to provide an improved device for cutting predetermined shapes in dry wall panels, glass or tiles.

Another object of this invention is to provide an improved drywall cutting device that has the ability for marking in dry wall panels, glass or tiles.

Still another object of this invention is to provide an improved cutting device for cutting in strips or perpendicular radius on openings in dry wall.

Yet another object of this invention is to provide an improved device that can efficiently cut in straight edges of drywall and in perfect radius.

These and other objects will become apparent to those skilled in the art in light of the following disclosure and accompanying drawings.

In accordance with the invention, generally stated, a device is provided for cutting and marking that is hand-held and easy to operate. The device includes an adjustable tool clamp for holding for all manual cutting or marking process and is also to able to slide the tool clamp along with two foot arm for easy adjustment.

The cutting device further includes a pivot point that is allowing to creating radius cut and making a clamping end for multiple tools. The pivot point is able to lock straight and follows a straight line.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of the cutting device of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

In construction industries Drywall is a product commonly used to finish building interiors. It is also known as plasterboard, wallboard, and gypsum board and also known as a panel made of gypsum plaster pressed between two thick sheets of paper. It is used to make interior walls and ceilings. Drywall is made of a core of gypsum that is sandwiched between two layers of heavy paper. Without the paper, the gypsum will crack and break apart easily. Gypsum is a soft white or gray rock that generates dust when it is cut. Tools that do not generate dust and that are designed for cutting the paper are best. To cut a straight line on the drywall, a short metal blade has been developed for electric-powered reciprocating tools that are designed specifically to cut holes into existing drywall.

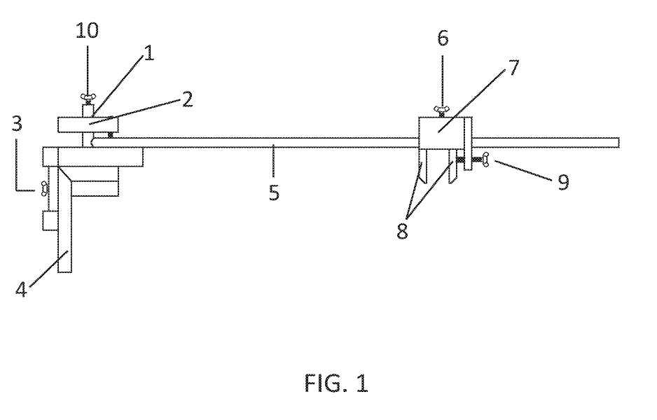

The present invention comprises a drywall cutting device, for marking and making cuts parallel or perpendicular to a reference edge of a drywall (gypsum wallboard) sheet. FIG. 1 of the present disclosure illustrates the use of the present device. The device essentially comprises a pivot pin 1, a head portion 2, a screw 3 for cutting circles, a decker 4, a tool arm 5, tool guide locking pin, a guide 7 for sliding along the arm, a stationary back 8, a clamping screw 9 and center pivot point 10 respectively.

The invention is used in its preferred embodiment by attaching a marking device to the drywall surface. The user then holds the drywall cutting device in one hand. After measuring the desired length, the tool arm 05 is moved such that the decker slides along with the drywall surface for straight cut. The adjustable tool clamp 08 holds all cutting and marking tools. The adjustable tool clamp 08 allows for easy adjustment for all the measurements ranges from 0-2 feet. The device is made from light weighted material like aluminum.

Use of the circle cutting device is as follows: The user selects the point on a sheet of drywall that the center point of a circular opening in the sheet. The user embeds the fixing guide locking pin 06 in the chosen center point by pressing on the pivot point 10. Then by choosing the appropriate groove for the size chosen hole, and inserting the drywall cutting device through the selected groove into the sheet of drywall. The user then pushes the tool arm 05, utilizing the end removal point 03, in a circle until completing a 360° arc, thus cutting or scoring a circular opening in the drywall.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

We claim:

1. A drywall cutting tool, comprising:
a T-shape member having a short head portion which can bear against one edge of the wall board and an elongated arm portion extending perpendicular from said short head portion;
a pivot pin;
a center pivot point;
a decker
a tool arm;
a guide aperture;
a guide locking pin; and
a clamping screw.

2. The drywall cutting tool according to claim 1, wherein pivot pin is fixed with the said center pivot point.

3. The drywall cutting tool according to claim 1, wherein decker is positioned for sliding along the surface of drywall.

4. The drywall cutting tool according to claim 1, wherein tool arm is positioned substantially perpendicular to said T-shaped member.

5. The drywall cutting tool according to claim 1, wherein guide aperture is incrementally spaced along the length of said tool arm.

6. The drywall cutting tool according to claim 1, wherein drywall cutting tool is made from light weight metal.

7. The drywall cutting tool according to claim 6, wherein the light weight metal is aluminum.

8. The drywall cutting tool according to claim 1, wherein clamping screw is threaded horizontally into said tool arm.
